(19) United States
(12) Patent Application Publication
(10) Pub. No.: US 2025/0107529 A1
(43) Pub. Date: Apr. 3, 2025

(54) LIGNIN-CONTAINING NANOCELLULOSE AND AG-AU-AG-CL NANOHYBRID AND GREEN FORMATION METHOD

(71) Applicant: The Curators of the University of Missouri, Columbia, MO (US)

(72) Inventors: Caixia Wan, Columbia, MO (US); Yisheng Sun, Columbia, MO (US); Kattesh Katti, Columbia, MO (US)

(21) Appl. No.: 18/642,226

(22) Filed: Apr. 22, 2024

Related U.S. Application Data
(60) Provisional application No. 63/501,750, filed on May 12, 2023.

(51) Int. Cl. A01N 59/16; A01N 25/10; A01P 1/00; C02F 1/50

(52) U.S. Cl. CPC A01N 59/16; A01N 25/10; A01P 1/00; C02F 1/505; C02F 2303/04

(57) ABSTRACT

A nanohybrid includes or consisting of Ag—Au—AgCl nanoparticles embedded in lignin-containing nanocellulose (LNC). A green method to form the nanohybrid includes mixing gold and silver metallic precursors in solution with LNC. The solution is maintained for a predetermined time period to permit Ag—Au—AgCl nanohybrid formation via reduction of the metallic precursors by the LNC.

### PRIORITY CLAIM AND REFERENCE TO RELATED APPLICATION

The application claims priority under 35 U.S.C. § 119 and all applicable statutes and treaties from prior U.S. provisional application Ser. No. 63/501,750, which was filed May 12, 2023.

### TECHNICAL FIELD

Fields of the invention include nanotechnology, metallic nanoparticles, and nanocomposites. Another field of the invention is antimicrobial agents.

### BACKGROUND

The present inventors and colleagues have previously developed stabilized gold nanoparticles encapsulated with proteins, peptides and small molecules. See, M. Khoobchandani, K. Katti, A. Maxwell, W. P. Fay and K. V. Katti, “Laminin Receptor-Avid Nanotherapeutic EGCg-AuNPs as a Potential Alternative Therapeutic Approach to Prevent Restenosis,” Int J Mol Sci. 17, (2016); R. Shukla, N. Chanda, A. Zambre, A. Upendran, K. Katti, R. R. Kulkarni, et al., “Laminin receptor specific therapeutic gold nanoparticles (198AuNP-EGCg) show efficacy in treating prostate cancer,” Proc Natl Acad Sci USA. 109:12426-3 (2012). Such nanoparticles were demonstrated to be retained in tumors through measurement of the gamma emission of Au-198 encapsulated nanoparticles, which allowed precise estimation of gold within tumor cells/tumor tissues down to sub nanomolar concentrations through scintigraphic counting techniques.

The present inventors have previously demonstrated stabilized gold nanoparticles that were encapsulated with polyphenol—flavonoids. Katti et al US Patent Publication US 2012/0134918 discloses Gum Arabic coated ¹⁹⁸Au nanoparticles, a method of making and a therapeutic and imaging agent. Katti et al. U.S. Pat. No. 8,333,994 discloses formation of gold nanoparticles via reduction using black tea, turmeric, curcumin or cinnamon or a similar naturally occurring polyphenols- or flavanoids-rich plant material. Katti U.S. Pat. No. 9,358,310 discloses stabilized, biocompatible gold nanoparticles that are stabilized with material from epigallocatechin Gallate (EGCg). These patents demonstrated that polyphenols- or flavonoids-rich plant material can be used to reduce gold salts and produce stabilized gold nanoparticles.

U.S. Pat. No. 8,241,393 provides a gold nanoparticle formation method. A gold salt is reacted with a phosphino amino acid. U.S. Pat. No. 8,057,682 describes methods of making and using and compositions of metal nanoparticles formed with solutions of plant extracts. Generally, the formation of nanoparticles and composites is unpredictable.

Metal nanoparticles have application as antimicrobial materials, and Ag nanoparticles have been recognized as a tool for combating multidrug-resistant pathogens. Zheng, K. et al. “Antimicrobial silver nanomaterials,” Coord. Chem. Rev. 2018, 357, 1-17. Bimetallic gold-silver nanoparticles (Au—AgNPs) exhibit superior antimicrobial properties with reduced silver loadings compared to monometallic AgNPs, likely due to activation of surface silver atoms by gold. Haleem, A. et al., “Highly porous cryogels loaded with bimetallic nanoparticles as an efficient antimicrobial agent and catalyst for rapid reduction of watersoluble organic contaminants,” J. Environ. Chem. Eng. 2021, 9, No. 106510.

Cellulose and lignin have been investigated for metallic nanoparticle synthesis, particularly based on their nanoscale particles, i.e., nanocellulose and nanolignin. Nanocellulose and nanolignin are mainly produced from fractionation and disintegration of lignocellulosic biomass, both seen as substitutes for petroleum-based polymers.

Many publications describe use of cellulose and lignin in the formation of metal nanoparticles. See, e.g., Frangville, C. et al., “Fabrication of Environmentally Biodegradable Lignin Nanoparticle,” ChemPhysChem 2012, 13, 4235-4243; Shi, Z. et al, “Enhanced colloidal stability and antibacterial performance of silver nanoparticles/cellulose nanocrystal hybrids,” J. Mater. Chem. B 2015, 3, 603-611; Kaushik, M. et al, “Reversing aggregation: direct synthesis of nanocatalysts from bulk metal. Cellulose nanocrystals as active support to access efficient hydrogenation silver nanocatalysts,” Green Chem. 2016, 18, 129-133.

The distinctive aromatic nature of lignin specifically makes it capable of absorbing heavy metals such as Ag⁺ ions in an aqueous environment. Richter, A. et al. “An environmentally benign antimicrobial nanoparticle based on a silver-infused lignin core,” Nat. Nanotechnol. 2015, 10, 817-823; Lintinen, K. et al. “Antimicrobial Colloidal Silver-Lignin Particles via Ion and Solvent Exchange,” ACS Sustainable Chem. Eng. 2019, 7, 15297-15303;

Nanocellulose and nanolignin can initiate the nucleation of heavy metal ions via reduction reactions. Rak, M. et al., “One-step, solvent-free mechanosynthesis of silver nanoparticle-infused lignin composites for use as highly active multidrug resistant antibacterial filters,” RSC Adv. 2016, 6, 58365-58370; Xiong, R et al., “Facile synthesis of tunable silver nanostructures for antibacterial application using cellulose nanocrystals,” Carbohydr. Polym. 2013, 95, 214-219.

Functional groups in nanocellulose/nanolignin are considered the sources of their reducing power, hypothetically making both materials potential for in situ synthesis of metallic nanoparticles without the use of other chemicals. Ifuku, S.; Tsuji, M.; Morimoto, M.; Saimoto, H.; Yano, H. Synthesis of Silver Nanoparticles Templated by TEMPO-Mediated Oxidized Bacterial Cellulose Nanofibers. Biomacromolecules 2009, 10, 2714-2717; She, Q. et al, “In situ synthesis of silver nanoparticles on dialdehyde cellulose as reliable SERS substrate,” Cellulose 2021, 28, 10827-10840; Chen, S. et al. “Synthesis of lignin-functionalized phenolic nanosphere supported Ag nanoparticles with excellent dispersion stability and catalytic performance,” Green Chem. 2020, 22, 2879-2888.

However, most studies of nanocellulose and nanolignin in metallic nanoparticle synthesis by far still have limitations in that they require other chemicals, extra energy input or surface functionalization for sufficient reducing power to produce nanoparticls. Islam, M. S. et al., “Mussel-Inspired Immobilization of Silver Nanoparticles toward Antimicrobial Cellulose Paper,” ACS Sustainable Chem. Eng. 2018, 6, 9178-9188; Pawcenis, D. et al., “Preparation of silver nanoparticles using different fractions of TEMPO-oxidized nanocellulose, Eur. Polym. J. 2019, 116, 242-255; Jia, X. et al., “Synthesis of gold-silver nanoalloys under microwave-assisted irradiation by deposition of silver on gold nanoclusters/triple helix glucan and antifungal activity,” Carbohydr. Polym. 2020, 238, No. 116169; Landge, V. K. et al, “Ultrasound-assisted wet-impregnation of Ag—Co nanoparticles on cellulose nanofibers: Enhanced catalytic hydrogenation of 4-nitrophenol,” J. Environ. Chem. Eng. 2021, 9, No. 105719; Ahmed, H. B. et. al., “Hydroxyethyl cellulose for spontaneous synthesis of antipathogenic nanostructures: (Ag&Au) nanoparticles versus Ag—Au nano-alloy,” Int. J. Biol. Macromol. 2019, 128, 214-229.

Moreover, nanolignin preparation relies on certain solvent systems, such as alkaline solutions and organic solvents, which is inconsistent with green synthesis. Chandna, S. et al., “Engineering Lignin Stabilized Bimetallic Nanocomplexes: Structure, Mechanistic Elucidation, Antioxidant, and Antimicrobial Potential,” ACS Biomater. Sci. Eng. 2019, 5, 3212-3227; Yang, W. et al., “Valorization of Acid Isolated High Yield Lignin Nanoparticles as Innovative Antioxidant/Antimicrobial Organic Materials, ACS Sustainable Chem. Eng. 2018, 6, 3502-3514.

Au—AgNPs synthesized by cellulose have used alkaline solvents to dissolve cellulose or lignin. Hu, X. et al., “Synthesis of bimetallic silver-gold nanoparticle composites using a cellulose dope: Tunable nanostructure and its biological activity,” Carbohydr. Polym. 2020, 248, No. 116777.

Lignin-containing nanocellulose (LNC) production does not require complete removal of lignin or extra processing for lignin nanofabrication and thus can reduce process complexity and lower production costs. Solala, I. et al., “On the potential of lignin-containing cellulose nanofibrils (LCNFs): a review on properties and applications,” Cellulose 2020, 27, 1853-1877.

Hu and Hsieh report successfully fabrication of monometallic AgNPs using lignin-coated cellulose clothes by mere boiling in pure water with no use of other chemicals. Hu, S. et al. “Synthesis of surface bound silver nanoparticles on cellulose fibers using lignin as multi-functional agent,” Carbohydr. Polym. 2015, 131, 134-141. This publication describes the simple deposit of lignin and AgNPs onto cellulose cloth. There is no incorporation of lignin into a nanoscale structure.

### SUMMARY OF THE INVENTION

A preferred embodiment provides a nanohybrid that includes or consists of Ag—Au—AgCl nanoparticles embedded in lignin-containing nanocellulose (LNC). A green method to form the nanohybrid includes mixing gold and silver metallic precursors in solution with LNC. The solution is maintained for a predetermined time period to permit Ag—Au—AgCl nanohybrid formation via reduction of the metallic precursors by the LNC.

### BRIEF DESCRIPTION OF THE DRAWINGS

FIG. 1 schematically illustrates a preferred process for fabricating an Ag—Au—AgCl nanohybrids embedded onto lignin-containing nanocellulose (LNC)

FIG. 2A is an image of nanoparticles- and nanohybrids-LNC samples formed in accordance with the invention;

FIG. 2B shows UV-vis spectra of the eight nanohybrids from the image of FIG. 2A;

FIG. 2C shows peak wavelengths and absorbances of pristine LNC, and nanoparticles- and nanohybrids-LNC samples;

FIG. 2D shows UV-vis spectra of samples using bleached nanocellulose for AgNPs, AuNPs, and nanohybrids synthesis;

FIGS. 3A-3H include TEM images and EDS spectra of monometallic AgNPs, AuNPs- and nanohybrids-LNC;

FIGS. 4A-4D are high-resolution XPS spectra of (4A) Ag 3d, (4B) Au 4f, and (4C) C is regions, and (4D) XRD patterns of pristine LNC, monometallic AgNPsLNC (T10), AuNPs-LNC (T01-1), and nanohybrids-LNCs;

FIGS. 5A and 5B respectively show FTIR whole-range and C═O range spectra with overlaid baselines of pristine LNC, monometallic AgNPs-LNC (T10), AuNPsLNC (T01-1), and nanohybrids-LNCs (T71-1 and T11-1);

FIGS. 6A-6D are images and data of the killing power of LNC, T10, T71-1, T11-1, and T01-1 together with a positive AgNPs control (NaBH₄—AgNPs), which was quantitatively determined by CFU reduction compared to the negative control using sterile water at 2.5, and 10 μg/mL loadings.

FIG. 7 shows Ag⁺ ion release over 12 hours from three samples containing different amounts of Ag and Au after dispersed into diluted LB medium.

FIG. 8A shows the effectiveness of water disinfection determined by the killing ratios of bacteria (both S. aureus and E. coli) after treated by 5 and 10 μg/mL of Ag—Au—AgCl nanohybrids-LNC (T71-1).

FIG. 8B shows the amounts of Ag and Au in water samples before and after absorption using AuNPs-LNC. Two water samples disinfected by different concentrations of Ag—Au—AgCl nanohybrids-LNC (5 and 10 μg/mL) were tested in the absorption test.

### DETAILED DESCRIPTION OF THE PREFERRED EMBODIMENTS

Preferred embodiments provide monometallic silver, gold nanoparticles, and Ag—Au—AgCl nanohybrids synthesized in situ utilizing lignin-containing nanocelluloses (LNCs) in a facile, chemical-free approach. Ag⁺ and Au3+ loadings as well as Au3+: Ag⁺ ratios can be used to control the nanoparticle synthesis.

Unlike Hu and Hsieh, preferred methods provide nanocellulose as a nanocarrier of AgAu nanohybrids. The AgAu-LNC hybrids can serve as a dispersible agent in water as well as a versatile building block of a variety of products, like films, fibers, hydrogels, aerogels, and so forth. Preferred bimetallic AgAu nanohybrids are also advantageous as they are capable of facilitating the synthesis of both AgNPs and AuNPs and also controlling Ag⁺ ions release in applications, while providing higher antimicrobial efficacy than mere AgNPs and AuNPs.

Nanohybrid-LNC synthesized at a low Au3+ loading level in accordance with the invention showed superior antibacterial activity with minimum inhibitory concentrations (MICs) at 5 μg/mL against model Gram-positive Staphylococcus aureus and 10 μg/mL against model Gram-negative Salmonella typhimurium, while releasing Ag⁺ ions at a lower level, when compared to monometallic AgNPs-LNC samples. The overall MICs of T71-1 were even lower than the silver equivalency values of many prior products, making it comparably effective at lower mass concentration.

Experiments demonstrating the invention show that LNCs can be used to synthesize metallic nanoparticles, and that both Ag/AgCl nanoparticles and Ag—Au—AgCl nanohybrids embedded onto LNCs can act as a potent antibacterial agent to fight against muti-drug resistant pathogens with reduced environmental effects. Nanocomposites of the invention are also likely to serve as antiviral and anticancer agents. LNCs can be used in synthesis methods of the invention for various monometallic and bimetallic nanoparticles, e.g., Ag—Pt, Ag—Fe.

Preferred embodiments of the invention will now be discussed with respect to experiments and drawings. Broader aspects of the invention will be understood by artisans in view of the general knowledge in the art and the description of the experiments that follows.

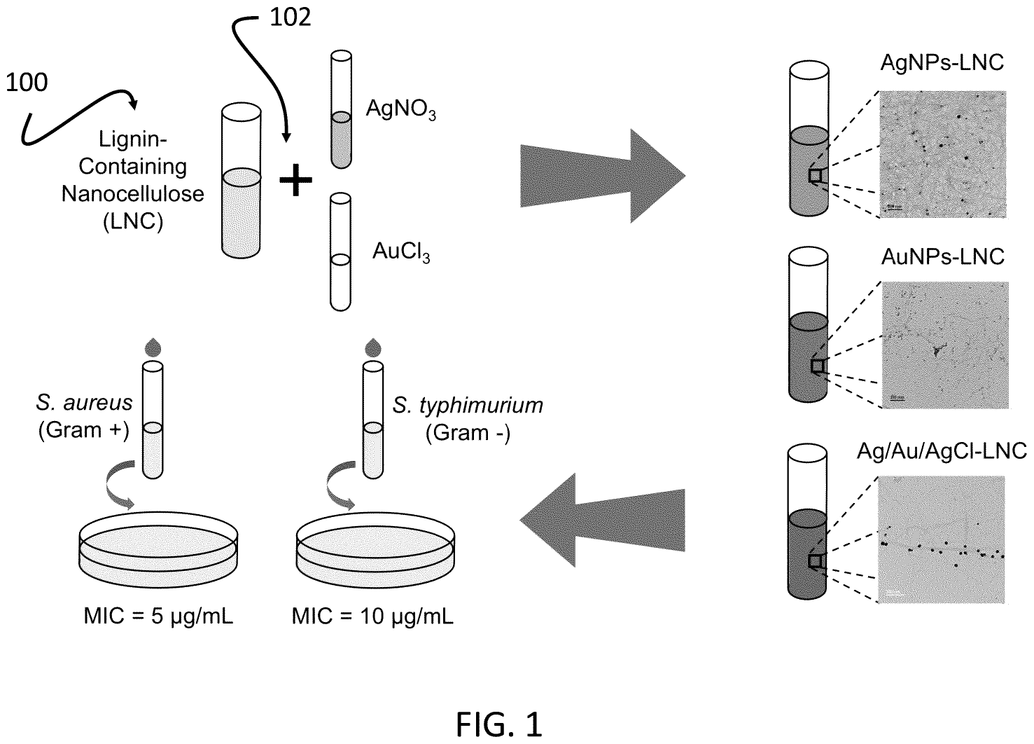

FIG. 1 schematically illustrates a preferred process for fabricating an Ag—Au—AgCl nanohybrids embedded onto lignin-containing nanocellulose (LNC). SEM images showed the distribution of Ag—Au—AgCl nanohybrids among LNC. The nanohybrids always existed in alignment with LNC or attached onto LNC. This is the definition of “embedded” as used herein, which is a reasonable description because metallic nanoparticles are understood to form where “capping” agents exist. This enables sizes to be controlled at nanoscale. In the present methods of formation, the capping agents are likely amorphous nanolignin and the functional groups (carboxyl) on nanocellulose surfaces.

LNC is prepared 100 in solution, then mixed with solutions of silver salt (AgNO₃) and gold salt (AuCl₃) 102. This forms LNC containing only Ag (AgNPs-LNC), only Au (AuNPs-LNC), and both Ag and Au (Ag—Au—AgCl nanohybrids-LNC), respectively. They were synthesized by mixing either Ag or Au precursor or both with LNC. In Ag—Au—AgCl nanohybrids-LNC synthesis, different ratios between Ag and Au precursors were applied to obtain different compositions, as discussed further below. All other variables, LNC concentration, temperature, synthesis time, no other chemical addition, were the same among different samples. FIG. 1 also shows that prepared nanohybrids were tested against Gram-positive and Gram-negative bacteria, i.e., Staphylococcus aureus and Salmonella typhimurium.

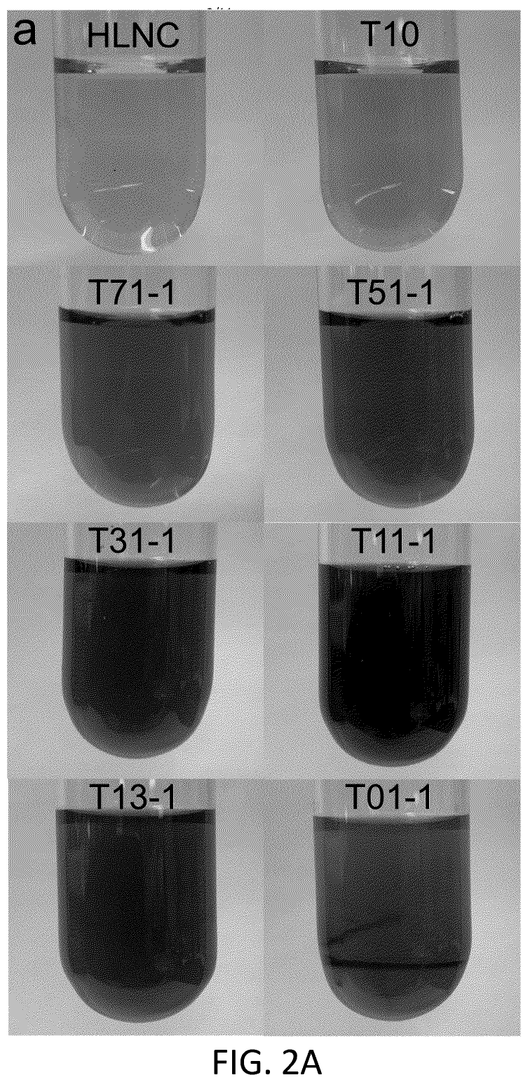

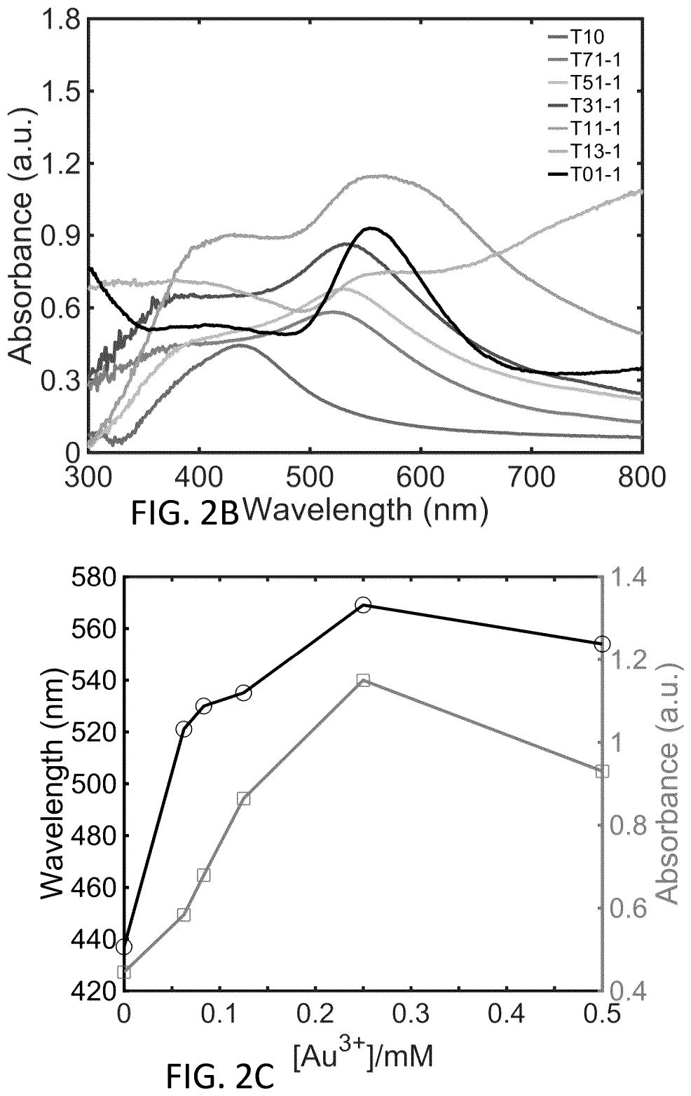

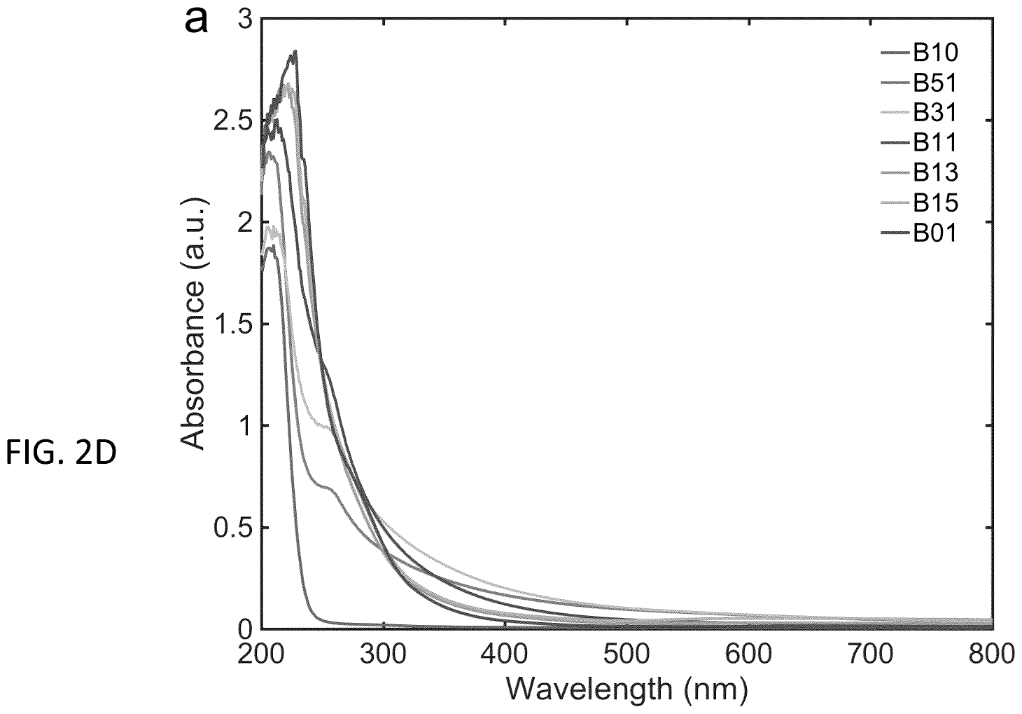

FIG. 2A is an image of nanoparticles- and nanohybrids-LNC samples formed in accordance with the invention. The successful synthesis of metallic nanoparticles and nanohybrids was first identified by the color change of the LNC suspensions. After 24 h, the monometallic AgNPs and AuNPs samples, T10 and T01-1, turned tawny and wine red, respectively, from the original light-tawny color of pristine LNC suspension. T01-1 also became slightly opaque and precipitates on the glass tube wall were observed, indicating potential aggregation of nanoparticles. In the nanohybrids-LNC samples, color changed differently when the ratios of precursors, i.e., AgNO₃ and AuCl₃, varied. Across the samples with lower [Au³⁺]/[Ag⁺] ratios, T71-1, T51-1, and T31-1, the colors were predominantly wine red but became darker as the [Au³⁺]/[Ag⁺] ratio increased. When the ratio increased, the colors of Ti1-1 and T13-1 became dark blue and dark green, respectively.

FIG. 2B shows UV-vis spectra of the eight nanohybrids from the image of FIG. 2A. The effect of localized surface plasmon resonance leads to the special colors of noble metal particles when their size drops down to nanoscale, in which their dipolar electromagnetic fields formed by oscillating surface electrons were highly enhanced, and therefore, light of similar frequency to the oscillating surface electrons will be strongly absorbed and scattered, leaving a characteristic peak on the spectrum. The characteristic peaks of spherical AgNPs and AuNPs are typically around 400-440 and 520-530 nm, respectively, but may vary depending on size, shape, and surrounding environment.

FIG. 2B shows characteristic absorbance peaks of the monometallic samples, T10 (AgNPs-LNC) and T01-1 (AuNPs-LNC), which were observed at 437 and 554 nm, respectively, indicating that AgNPs and AuNPs were successfully synthesized by LNC. The peak of T01-1 slightly red-shifted, and its absorbance of far-red lights (700-800 nm) became stronger, potentially due to size growth of AuNPs and the LNC aggregation being observed. Since the LNC particles possessed negative surface charges (−potential=−41.94 mV), the results indicated that trivalent Au³⁺ ions might induce LNC aggregation more easily than monovalent Ag⁺ ions at a lower concentration. In the nanohybrids-LNC samples, absorbance plateaus rather than single peaks were observed from around 400 to 560-600 nm, which varied depending on [Au³⁺]/[Ag⁺] ratios.

The e absorbance peak of Au—Ag nanoalloys is known to shift from 395 to 525 nm as the molar fraction of Au increased from 0 to 1. A similar trend was observed when extracting the maximum absorbance over [Au³⁺]/[Ag⁺] ratios (FIG. 2C). FIG. 2C shows peak wavelengths and absorbances of pristine LNC, and nanoparticles- and nanohybrids-LNC samples.

Therefore, the absorbance plateaus were most likely caused by the coexistence of AgNPs, AuNPs, and Ag—Au alloys in distinct compositions. On the other hand, as Cl⁻ ions in AuCl₃ can combine with Ag⁺ ions to generate AgCl, i.e., Ag⁺+Cl⁻→AgCl, AgCl could also pose an effect on the UV-vis absorbance. When existing individually, AgCl does not exhibit characteristic absorbance peaks, nor does exhibit significant absorbance of visible light (400-800 nm). However, the Ag/AgCl nanocomposite showed an overall enhanced absorbance plateau over UV and visible light spectra. This increased absorbance was most likely attributed to enhanced surface plasmon resonance of AgNPs when deposited on the surface of AgCl. As shown in FIG. 2B, sample T13-1 exhibited an absorbance plateau between 200 and 800 nm with no distinguishable peaks, implying a dominant AgCl formation. Such absorbance-enhancing effect should also exist in the other nanohybrids-LNC samples, albeit at varying levels depending on the concentrations of Ag⁺, Au³⁺, and Cl⁻ in synthesis.

To better understand the role of lignin in the synthesis of nanoparticles, reactions utilizing bleached nanocellulose (BNC) (98.48 wt % cellulose and <1 wt % lignin) with similar [Au³⁺]/[Ag⁺] ratios were conducted as summarized in the following table.

| | | | | | BNC/ | | | |
|---|---|---|---|---|---|---|---|---|
| | Initial | Initial | Initial | AgNO₃/ | (AgNO₃ + | Final | Final | |
| | BNC | [Ag⁺] | [Au³⁺] | AuCl₃ | AuCl₃) | [Ag⁺] | [Au³⁺] | [Au³⁺]/[Ag⁺] |
| Sample ^{a} | (wt %) ^{b} | (mM) ^{b} | (mM) ^{b} | (v/v) | (v/v) | (mM) | (mM) | molar ratio |
| B51-1 | 0.1 | 5 | 1 | 5:1 | 1:1 | 2.08 | 0.08 | 0.040:1 |
| B31-1 | 0.1 | 5 | 1 | 3:1 | 1:1 | 1.88 | 0.13 | 0.067:1 |
| B11-1 | 0.1 | 5 | 1 | 1:1 | 1:1 | 1.25 | 0.25 | 0.200:1 |
| B13-1 | 0.1 | 5 | 1 | 1:3 | 1:1 | 0.63 | 0.38 | 0.600:1 |
| B15-1 | 0.1 | 5 | 1 | 1:5 | 1:1 | 0.42 | 0.42 | 1.000:1 |
| B10 | 0.1 | 5 | — | 1:0 | 1:1 | 2.50 | 0 | 0 |
| B01-1 | 0.1 | — | 1 | 0:1 | 1:1 | 0 | 0.50 | — |

^{a} Labeling of samples is in the format of Bab-c, where B represents bleached nanocellulose (BNC), ab is volumetric ratio of AgNO₃/AuCl₃ solutions, and c is initial [Au³⁺] in mM.
^{b} Initial concentrations of LNC, Ag⁺ and Au³⁺ referred to the measures of the components in their individual suspension or solutions before mixing, and final concentrations referred to the measures of corresponding component after mixing.

After 24 h reaction, all the samples exhibited no absorbance peaks except strong absorbances between 200 and 300 nm, as seen in FIG. 2D, which were most likely caused by unreacted AgNO₃ and AuCl₃ Although AgCl might form without concurrent synthesis of metallic nanoparticles, AgCl alone could not cause light absorbance. The results demonstrated that nanocellulose alone could not serve as a powerful reducing and capping agent to reduce Ag⁺ and Au³⁺ ions under the given condition, underscoring the significant role of lignin in metallic nanoparticles synthesis.

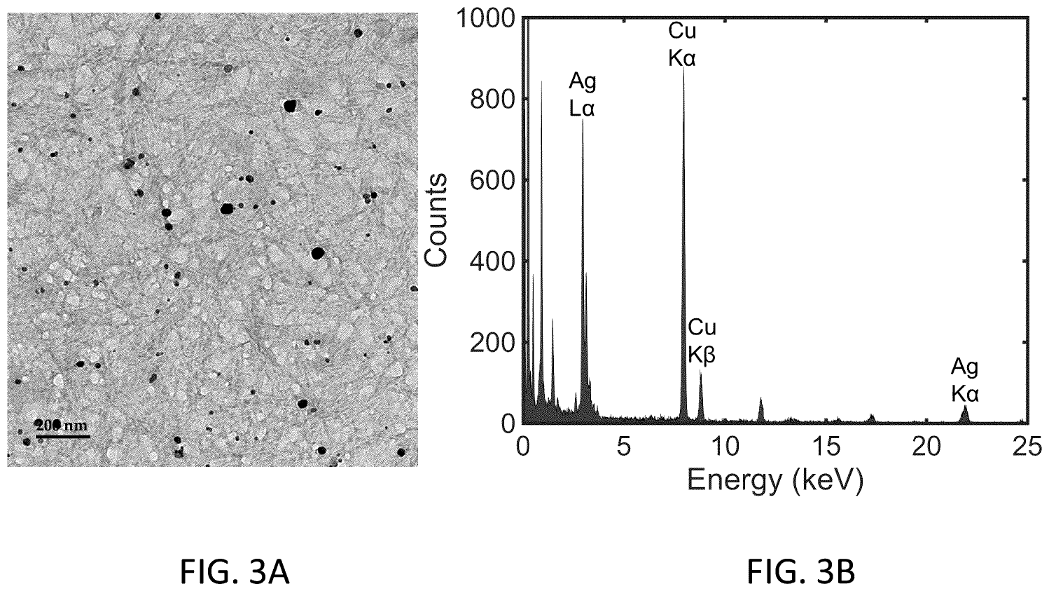

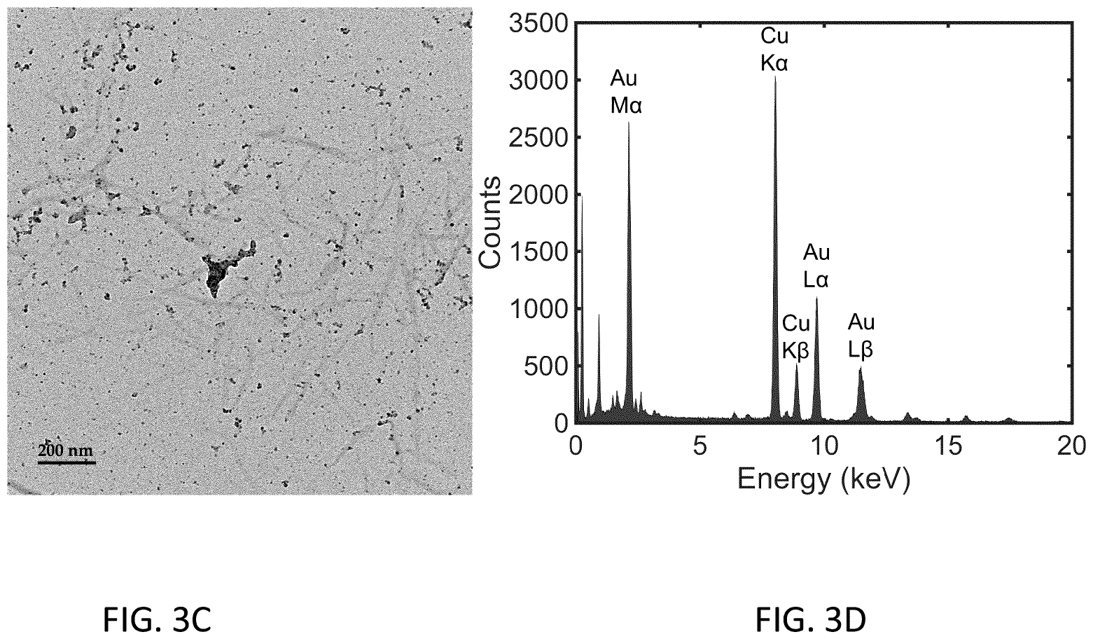

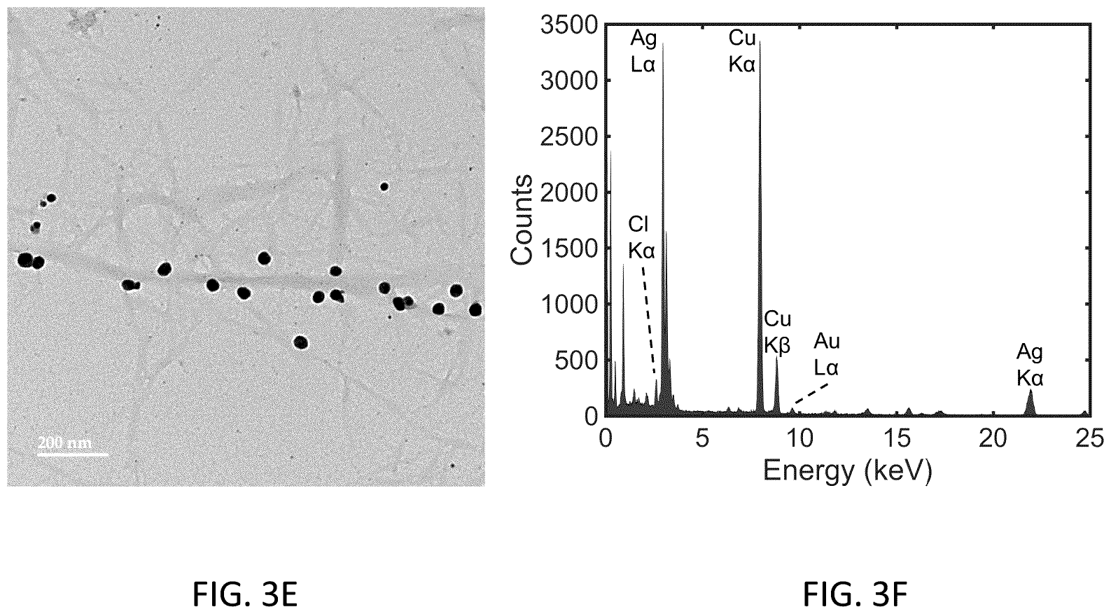

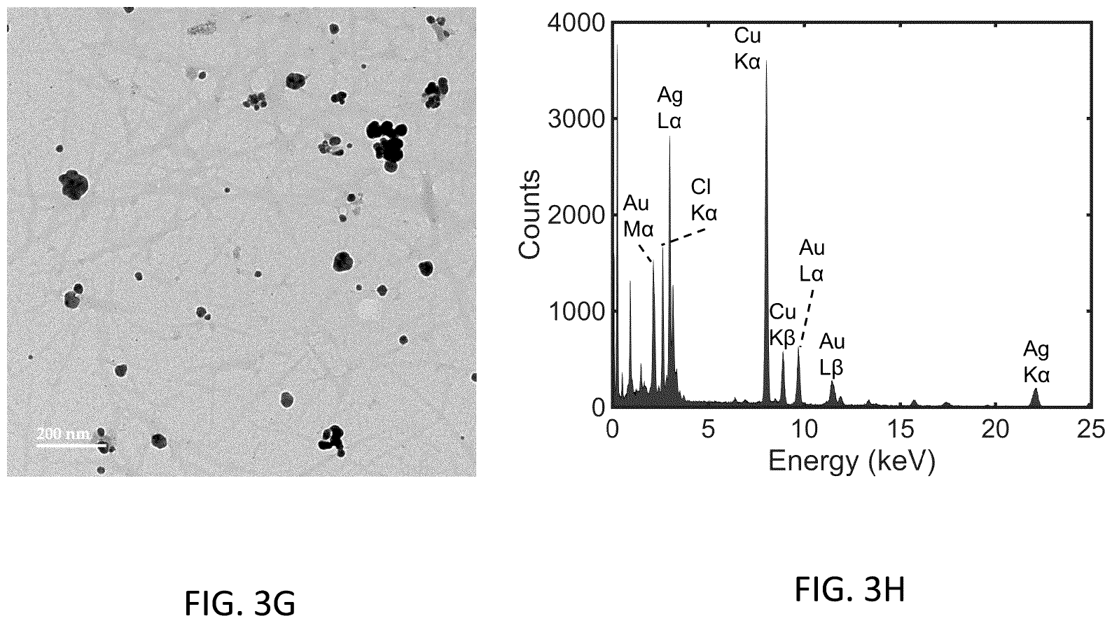

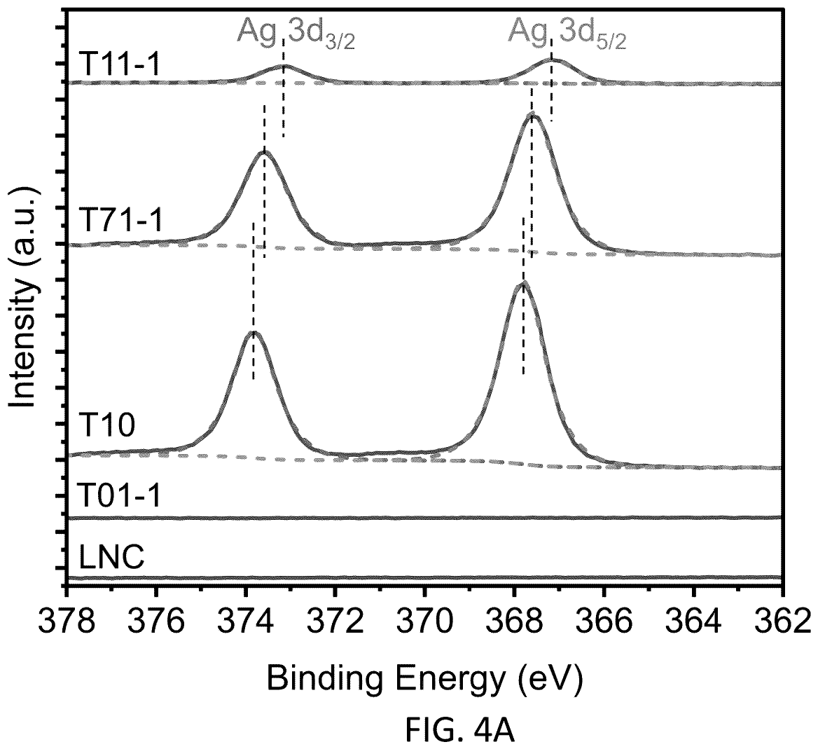

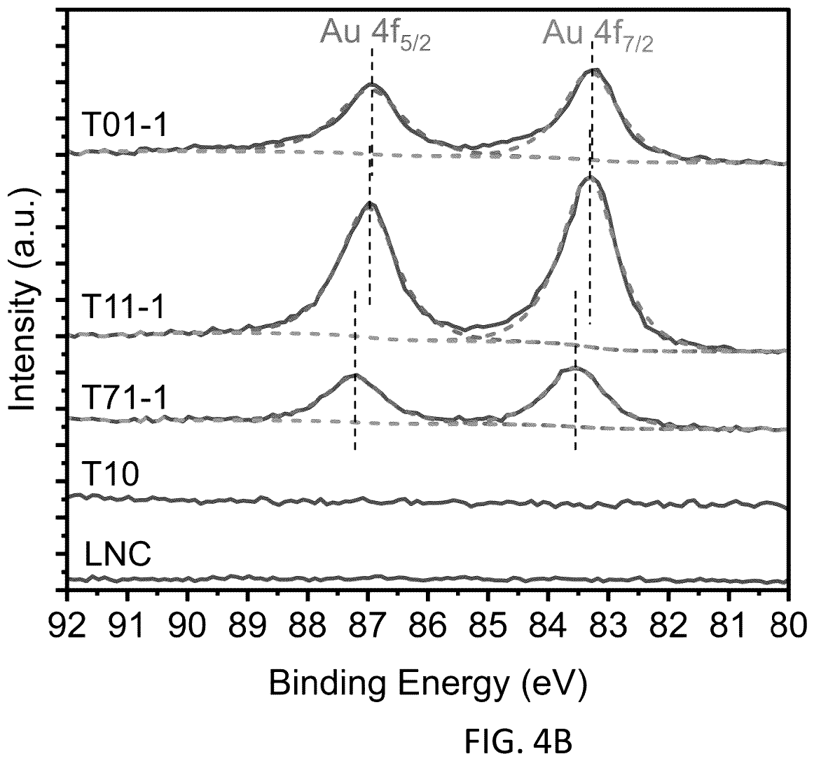

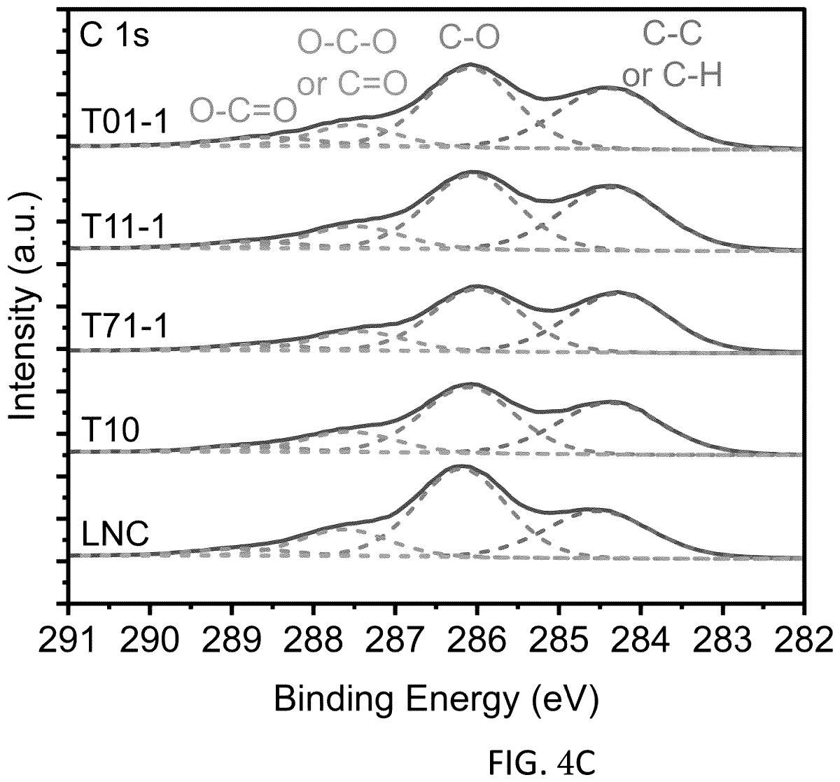

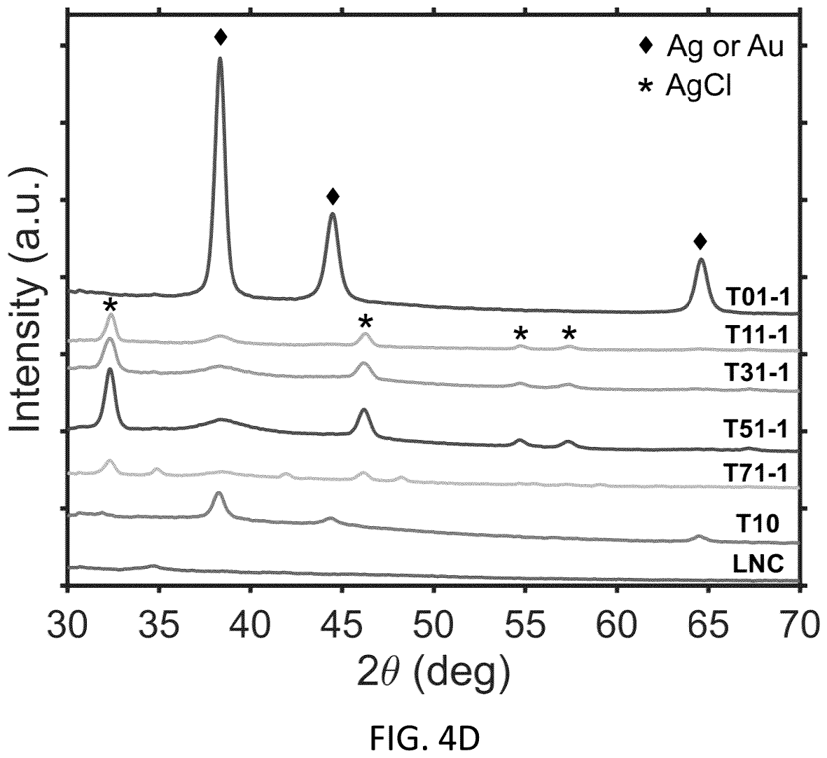

FIGS. 3A-3H include TEM images and EDS spectra of monometallic AgNPs, AuNPs- and nanohybrids-LNC. The morphology and elemental composition of two monometallic samples, T10 (FIGS. 3A and 3B) and T01-1 (FIGS. 3C and 3D), together with two nanohybrids-LNC samples, T71-1 (FIGS. 3E and 3F) and T11-1 (FIGS. 3G and 3H), were determinized using TEM equipped with an EDX detector. Throughout all the four samples, nanoparticles were observed adhering to the network structures formed by LNC. In nanohybrid T71-1 and T11-1, the metallic nanoparticles looked bigger in size, while aggregates were more frequently found in T11-1, which was likely attributed to the formation of AgCl and coexistence of different types of nanoparticles. In the EDX spectra, the Cl signal was only detected in the spectra of nanohybrids-LNC samples, implying that it existed in AgCl. Comparing T71-1 and T11-1, the Cl signal was greater in T11-1, indicating that AgCl formation was promoted under conditions of increased [Au³⁺]/[Ag⁺] ratios. All samples containing both Ag and Au by the present methods should contain AgCl, which the Au/Ag mixing ratio does not affect much. Theoretically, the ksp of AgCl is at the level of 10-10 level at 25° C., meaning that the concentration product of [Ag⁺][Cl⁻] must be lower than that value in {mole/L}2. This only allows Ag⁺ or Cl⁻ or both in too low concentrations to be applicable with the present synthesis method. As experiment evidence, all characterized AgAu nanohybrids-LNC samples showed the existence of AgCl, in EDS (FIG. 3F & 3H), XPS (FIG. 4A), and XRD (FIG. 4D).

Understanding the Mechanism of Nanohybrid Synthesis. To better understand the mechanism of nanoparticles synthesis by LNCs, the samples synthesized with different [Au³⁺]/[Ag⁺] ratios were characterized by XPS. The table below summarizes the XPS results, which are graphically shown in FIGS. 4A-D.

TABLE S3
Percent peak area of deconvoluted C
1s and O 1s peaks in XPS analysis.

| | C 1s | | | | O 1s | |
|---|---|---|---|---|---|---|
| | C—C/ | C—O | O—C—O/ | O—C═O | C—O | C═O |
| Sample | C—H (%) | (%) | C═O (%) | (%) | (%) | (%) |
| LNC | 31.32 | 49.61 | 14.75 | 4.32 | 98.04 | 1.96 |
| T10 | 42.75 | 40.84 | 12.34 | 4.06 | 94.55 | 5.45 |
| T71-1 | 40.31 | 42.66 | 12.79 | 4.23 | 96.94 | 3.06 |
| T11-1 | 38.68 | 43.88 | 13.33 | 4.10 | 98.14 | 1.86 |
| T01-1 | 39.37 | 44.05 | 10.92 | 5.66 | 91.66 | 8.34 |

In the whole-range surveys, the characteristic O1 s and C1 s peaks were found across all the samples including the pristine LNCs, while the peaks of Ag, Au, and Cl were also observed in specific nanoparticles- and nanohybrids-LNC samples. The characteristic Ag 3d peaks were detected in T10, T71-1, and T11-1 but not in the monometallic AuNPs-LNC sample, T01-1. In monometallic T10, Ag3 d_{3/2} and Ag3 d_{5/2} peaks were found at 373.81 and 367.81 eV, respectively, matching well with the binding energy of Ag^{0.61} Silver oxides, namely, Ag₂O and AgO, are common impurities in AgNPs synthesis, which lead to slight negative shifts of the Ag3 d peaks and could be difficult to distinguish from Ag⁰ merely based on Ag spectra. Therefore, the O 1s spectra were concurrently inspected to distinguish Ag⁰ versus silver oxides, as silver oxides show peaks between 529.2 and 528.4 eV. However, the signals within that region were almost negligible through all the samples analyzed, indicating that the formation of Ag₂O and AgO was insignificant. In addition, in Ag nucleation, when AuCl₃ was added, the Ag3 d₃/2 and Ag3 d_{5/2} peaks shifted to 373.58 and 367.58 eV in T71-1, and 373.16 and 367.15 eV in T11-1, respectively, showing a negative shift as the ratio of [Cl⁻]/[Ag⁺] increased. Such correlation indicated that the formation of AgCl could be the cause of XPS peak shifts. Ag—Au alloy could also cause similar peak shifts of Ag, while positively shifting Au4f peaks. In FIG. 4B, compared to monometallic T01-1, the characteristic Au4f_{7/2} peaks of T11-1 and T71-1 shifted by +0.03 and +0.25 eV, respectively, which indicate the formation of Ag—Au alloy. Following the order of T01-1, T11-1, and T71-1, the [Au³⁺]/[Ag⁺] ratio decreased, which implied that the formation of Ag—Au alloy was enhanced when Ag⁺ was in exceeding quantity, likely because Ag⁺ preferentially bonded with Cl⁻. The state of Cl was also inspected to confirm the formation of AgCl. In nanohybrid T71-1 and T11-1, C12p_{3/2} and 2p_{1/2} peaks were found around 197.4 and 199.1 eV, respectively, consistent with the reported binding energy in metal chlorides. In monometallic T01-1, C12 p peaks were found at the same positions, which might be attributed to residual AuCl₃ or Cl⁻ ions attached on the surface of AuNPs. Moreover, an extra minor peak was found at 201.59 eV in T011, likely assigned to organic chloride compounds, which could be attributed to side reactions between AuCl₃ and LNCs when no Ag⁺ existed. In the C1 s spectra, four peaks were deconvoluted at approximately 284.4, 286.1, 287.5, and 288.7 eV, assigned to carbon atoms in C—C/C—H, C—O, O—C—O/C═O, and O—C═O bonding, respectively, and no obvious differences in position were found through all the samples. Compared to pristine LNCs, the peak concentration of C—C/H increased from 31.32% to around 40% in all the nanoparticles- and nanohybrids-LNC samples (T01-1, T11-1, T71-1, T10), while their C—O concentrations decreased from 49.61 to 40.84-44.05% and O—C—O and C═O concentrations decreased from 14.75 to 10.92-13.33%. Such concentration changes inferred that the reduction of Ag⁺ and Au³⁺ potentially involved oxygen-containing functional groups such as hydroxyl and aldehyde groups on LNCs. Meanwhile, the concentrations of carboxyl (O—C═O) groups remained relatively constant before and after the syntheses. XRD was also utilized to identify the crystal structures of Ag and Au nanoparticles and nanohybrids (FIG. 4D). In T10 and T01-1, characteristic Bragg reflection peaks of mere Ag⁰ and Au⁰ were found, whereas AgCl peaks appeared along with those of silver or gold in all nanohybrids-LNC samples, indicating the coexistence of Ag⁰, Au⁰, and AgCl.

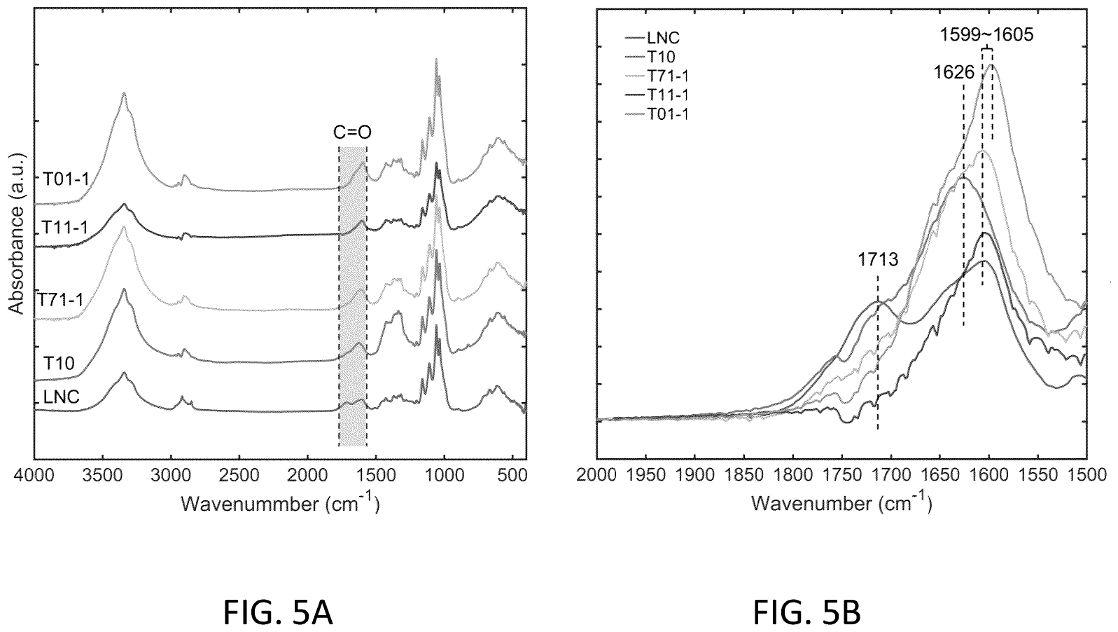

FIGS. 5A and 5B respectively show FTIR whole-range and C═O range spectra with overlaid baselines of pristine LNC, monometallic AgNPs-LNC (T10), AuNPsLNC (T01-1), and nanohybrids-LNCs (T71-1 and T11-1). Absorbance changes were found within the region of C═O stretching (FIG. 5A) which was likely related with carboxyl groups in LNCs. After overlaying the spectra on the same baseline (FIG. 5B), absorbance peaks at 1713 and 1605 cm⁻¹ were found in pristine LNC corresponding to acidic COH and carboxylate salts (COO⁻). The absorbance at 1713 cm⁻¹ almost completely disappeared in all the other samples after nanoparticles synthesis. Considering that the carboxyl (O—C═O) groups were not consumed based on XPS spectra, their absorbance peaks on FTIR spectra could shift to other locations within the region due to different binding states. In monometallic T10, the peak at 1605 cm⁻¹ also disappeared while a major absorbance was observed at 1626 cm⁻¹, which might be attributed to the interaction between carboxyl groups and AgNPs. In T01-1, the main absorbance was observed at 1599 cm⁻¹, which did not shift noticeably from 1605 cm⁻¹ in pristine LNC and indicated that AuNPs did not strongly interact with carboxyl groups. In nanohybrid T71-1 and Ti1-1, the major absorbance peaks appeared at 1605 cm⁻¹, shifted from 1626 cm⁻¹ in T10, suggesting removal of the interactions between AgNPs and carboxyl groups.

The synthesis kinetics of Ag—Au—AgCl nanohybrids were investigated with various Au³⁺ concentrations and [Au³⁺]/[Ag⁺] ratios (1:1 3:1 5:1 7:1 9:1) over the course of 24 h reaction. Continuous formation of nanoparticles was demonstrated by the increasing absorbances of all samples over time. The position of the maximum absorbance of each sample did not change significantly, indicating that the chemical composition of nanohybrids at each specific [Au³⁺]/[Ag⁺] ratio remained relatively stable over time. The synthesis mechanisms were further analyzed by extracting the data of maximum absorbances between 500 and 600 nm, their positions, and absorbances at 800 nm, and statistically analyzing their potential correlations with metal ions loadings and their mixing ratios. Linearity between the peak position and [Au³⁺]/[Ag⁺] ratio was higher than 92%, while the linearity between peak absorbance and Au³⁺ concentration was higher than 93%. At higher Au³⁺ concentrations, i.e., [Au³+]≥0.63 mM or [Au³⁺]/[Ag⁺]≥0.33:1, the absorbances deviated from the linear regressions as the ion loadings might exceed the synthesis capacity of LNC and aggregation overrode the formation of individual nanoparticles. Both LNC aggregation and formation of Ag—AgCl composites could potentially enhance far-red light absorbances. 800 nm absorbances linearly correlated with Au³⁺ concentration and [Ag⁺][Cl⁻] concentration by over 95 and 89%, respectively, which provided evidence supporting the far-red light absorbance. Meanwhile, as the Au³⁺ and Cl⁻ ions came from the same source, it remains unclear whether Au³⁺ or AgCl was playing the dominant role in far-red light absorbance.

Antibacterial Activities. Antibacterial activities of the monometallic nanoparticles- and nanohybrids-LNC samples were evaluated against two pathogenic bacterial strains, i.e., S aureus (Gram-positive) and S. typhimurium (Gram-negative).

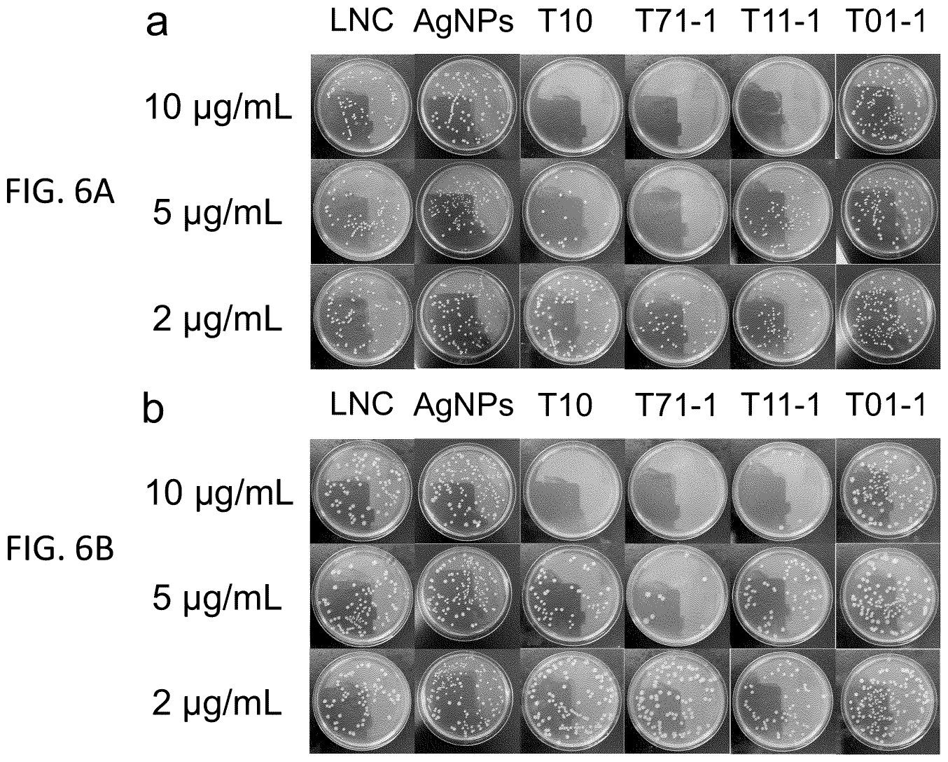

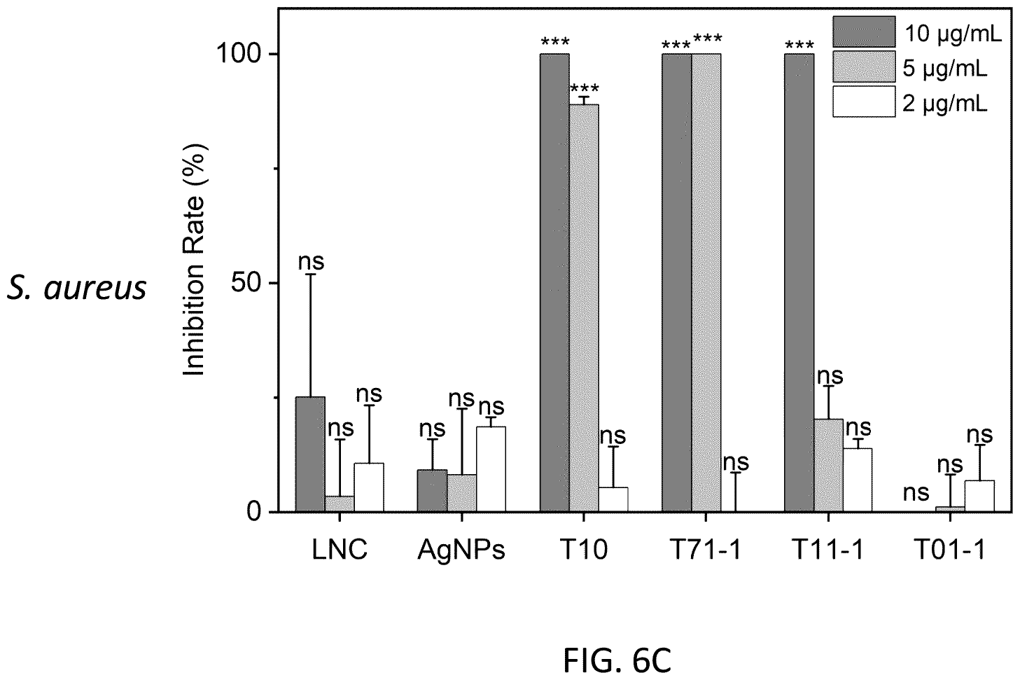

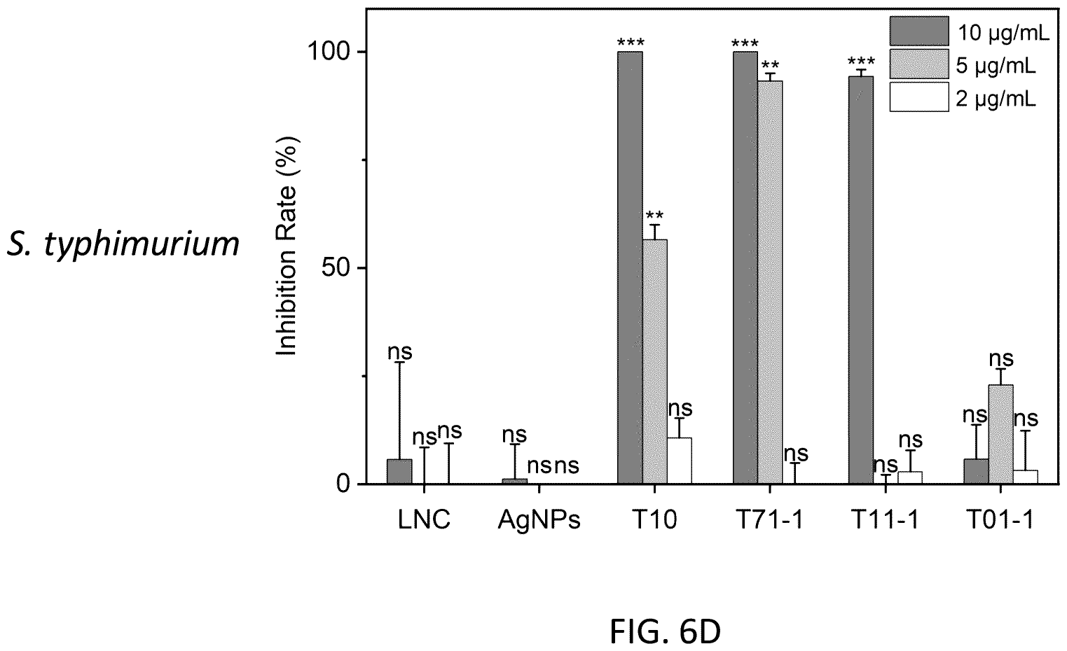

FIGS. 6A-6D are images and data of the killing power of LNC, T10, T71-1, T11-1, and T01-1 together with a positive AgNPs control (NaBH₄—AgNPs), which was quantitatively determined by CFU reduction compared to the negative control using sterile water at 2.5, and 10 μg/mL loadings. On S. aureus, T10, T71-1, and T11-1 completely inhibited its bacterial growth at 10 μg/mL, while T01-1 and LNC had no significant inhibitory effect. T71-1 was the only sample that inhibited S. aureus growth completely at 5 μg/mL, a significantly low minimum inhibitory concentration (MIC) among AgNPs-based antimicrobial agents (Table 1). In contrast, T10 had an inhibition rate of 88.93% at the same loading, while T11-1 did not inhibit the bacterial growth significantly. NaBH₄—AgNPs, a classic AgNPs sample, also did not show any significant inhibition at concentrations 10 μg/mL. This comparison corroborated that the antibacterial activity of AgNPs was enhanced when the nanoparticles were in situ synthesized and embedded in the LNC matrix. On S typhimurium, only T10 and T71-1 achieved a full inhibition of bacterial growth at 10 μg/mL, while T11-1 inhibited 94.29% growth at the same loading. At 5 μg/mL, only T10 and T71-1 showed significant inhibition effects by 56.57 and 93.24%, respectively. Across all the loadings, LNC, T01-1, and NaBH₄ AgNPs did not significantly inhibit bacterial growth of S. typhimurium (p>0.05). When the sample loading dropped down to 2 μg/mL, no significant inhibitory effects were observed across all the samples.

To gain a better understanding of the killing mechanism, TEM imaging of S. aureus and S. typhimurium cell structures after 30 min exposure to a nanohybrids-LNC sample (T71-1) was performed. In the S. aureus sample, cell membranes of some cells showed blurred boundaries, implying a disruptive effect of nanohybrids-LNC. In S. typhimurium, cell collapse was more noticeable than membrane corruption, as evidenced by morphological changes in the cells. Similar to other silver-based bactericides, rupture of the cell membrane and subsequent leakage of intracellular contents could be one of the mechanisms underlying the antibacterial activities of nanohybrids-LNC.

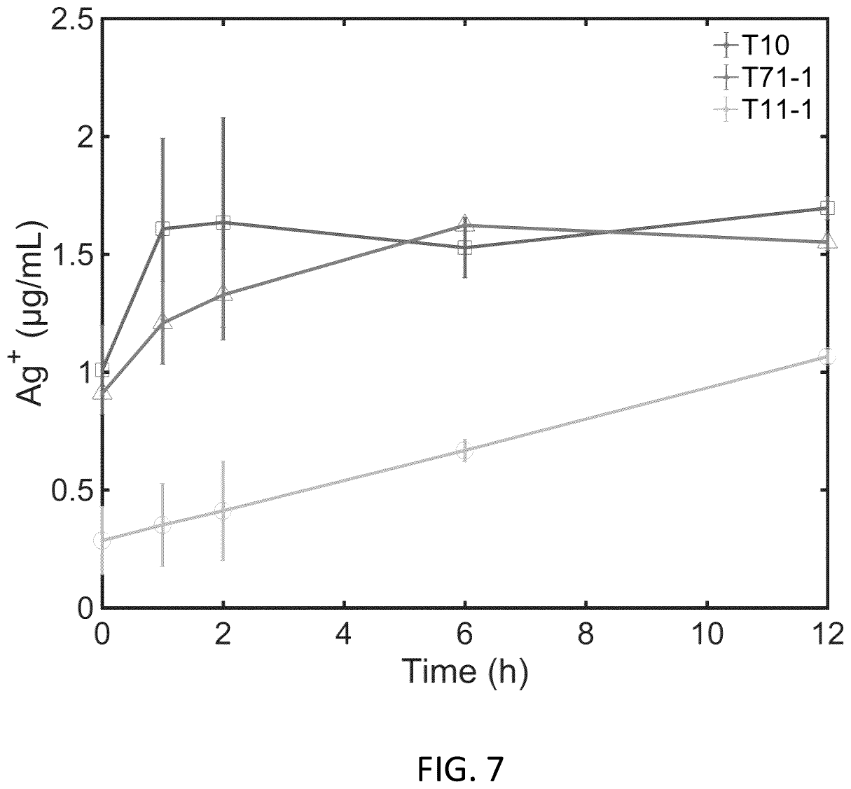

Furthermore, Ag⁺ ion release over time was investigated by ICP-OES, and results are shown in FIG. 7. FIG. 7 shows the Ag⁺ release over 12 hours from samples containing different amounts of Ag and Au after dispersed in diluted LB medium. A clear comparison is provided in FIG. 7 indicating that Ag⁺ release became slower with higher amounts of Au. This is important for use in situations when high Ag⁺ release rate is a concern due to its toxicity. A nanohybrid sample of the invention released as low as 0.4 μg/mL Ag⁺ ions when killing all bacteria, and most Ag⁺ ions were then successfully re-absorbed by AuNPs-LNC to moderate its environmental effects.

To mimic cell culture environment, diluted LB media, same as that used in the antibacterial test, were utilized for dispersing T10, T71-1, and T11-1. Among all three samples, T10 released Ag⁺ ions most quickly, reaching 1.61 μg/mL of Ag⁺ within the first hour and tending to level off. Ag⁺ release in T71-1 was slower than that in T10 at the first few hours and then reached a similar level. The coexisting Au and AgCl could be the cause of slower Ag⁺ release in T71-1. When more Au and AgCl existed, as in T11-1, Ag⁺ release slowed further and only reached 1.07 μg/mL after 12 h release. Together with the MIC results, the Ag⁺ release kinetics clearly indicated the controlled Ag⁺ release on antibacterial performances of the nanohybrids. It should be noted that if Ag⁺ release was oversuppressed, the antibacterial performances of a nanohybrid would likely be compromised. In comparison to the monometallic T10 and silver-based antibacterial reported previously, T71-1 was among the most effective, implying an enhanced antibacterial activity potentially due to the coexistence of Ag—Au—AgCl in the nanohybrids. The overall MICs of T71-1 were even lower than the silver equivalency values of many previously reported AgNPs-based products, making it comparably effective at a lower mass concentration. The environmental effects of nanohybrids-LNC would be much milder as its Ag⁺ ion release was highly controlled. The outstanding performance can be attributed to the synergistic effects between the three constituents of the nanohybrid. In addition, Ag—AgCl nanohybrids, also known as a photocatalyst, could generate ROS under visible light, which could reinforce the ROS induced by Ag⁺ ions and thus enhance the antibacterial activity of the nanohybrids. On the other hand, when the amounts of Au³⁺ and Cl⁻ were increased during synthesis, as in T11-1 versus T71-1, both Ag⁺ ion release and antibacterial activity of the nanohybrids-LNC were significantly reduced, implying that the loading ratio of Ag—Au—AgCl plays an important role in determining the antibacterial activity of the nanohybrids. The nanohybrids-LNC composite exhibited superior antibacterial activities against both Gram-positive and Gram-negative bacterial strains, with low levels of Ag⁺ ions release.

In the experiments, the amount of precursors and their ratios utilized in synthesis were controlled, and the product quality remained stable and consistent as monitored by UV-vis and antibacterial tests. Among all samples, T71-1, applying a 7:1 volume ratio of AgNO₃/AuCl₃ (molar ratio of [Au3+]/[Ag⁺]=0.029:1) performed best as discussed with respect to antibacterial tests. T91-1 and T51-1 also had good antibacterial power. A preferred ratio of [Au3+]/[Ag⁺] is 0.022-0.040:1 for antibacterial applications. When [Au3+]/[Ag⁺] goes higher, Ag⁺ ion release is further suppressed by AuNPs, reducing the antibacterial power. However, that composition is expected to perform well when low level of Ag⁺ ion release or a higher content of Au is desired. Example applications that benefit from such characteristics include as a catalyst, as food packaging, as an antibacterial surface coating, as antibacterial fiber or clothes, and other applications where a lower level of silver release (higher relative Au content) is favored.

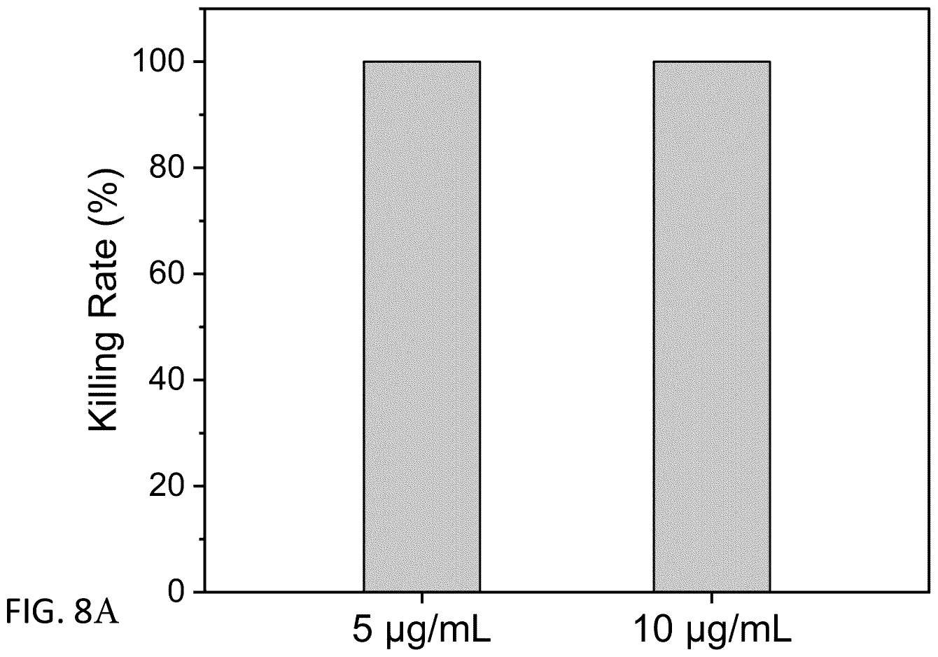

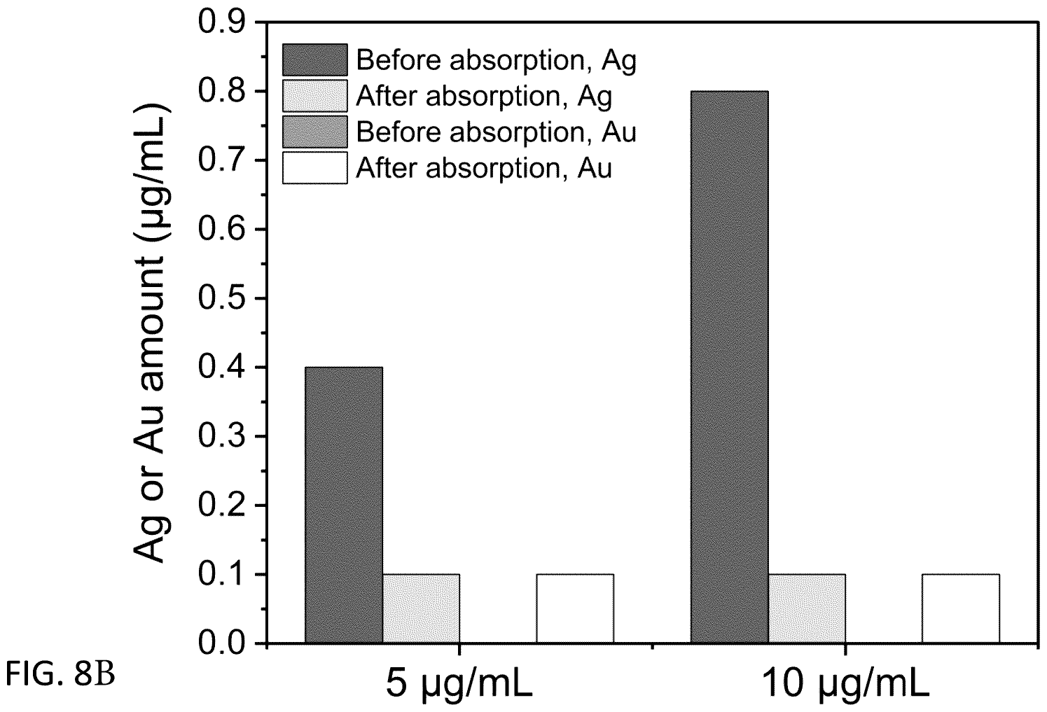

Finally, this Ag—Au—AgCl nanohybrids-LNC material (T71-1) was tested in an experiment that mimics water treatment, by disinfecting water samples contaminated with both S. aureus and E. coli strains (each at 105 CFU/mL). After disinfection, AuNPs-LNC was utilized to absorb Ag⁺ ions released by the nanohybrids, trying to eliminate the environmental toxicity by Ag. FIG. 8A showed that water after disinfection and disinfected water after Ag⁺ absorption were both colorless and clear. A 100% disinfection was achieved after 30-min treatment with as low as 5 μg/mL of T71-1, as shown in FIG. 8B. As both S. aureus and E. coli inoculated in the water sample, the disinfection was testified effective against both Gram-positive and Gram-negative strains commonly existing in natural surroundings. Furthermore, as the Ag⁺ ions released during disinfection could cause concern due to their environmental toxicity, an absorption test was conducted using AuNPs-LNC as the absorbent, relying on its reactivity of in situ reduction of Ag+ ions. In FIG. 8C, the amounts of Ag and Au remaining in the water samples before and after absorption were analyzed. After disinfection, 0.4 and 0.8 μg/mL of Ag+ ions were released from 5 and 10 μg/mL of T71-1 samples, respectively, which showed a direct correlation between nanohybrids-LNC concentration and Ag⁺ ions release. Then, after absorption using 10 μg/mL of AuNPs-LNC, only 0.1 μg/mL was detected in water samples treated by both 5 and 10 μg/mL of T71-1, indicating effective removal of Ag⁺ ions. As for Au³⁺ ions, their release from T71-1 was undetectable (<0.1 μg/mL), and after absorption there were 0.1 μg/mL of Au detected likely due to mild release from AuNPs-LNC. Collectively, this nanomaterial could serve as a highly effective disinfectant of water as well as a powerful absorbent of Ag⁺ ions. The facile reaction reported in this study is an excellent fit to water treatment applications without introducing many technical challenges, but, furthermore, may provide a novel green mechanism of utilization of Ag-based nanomaterials by controlling, recycle, and even reuse of Ag⁺ ions.

### Experimental Details

Materials. Switchgrass was collected from the South Farm at the University of Missouri in Columbia, Missouri, USA. It was air-dried, ground through a 2 mm screen, and stored in an airtight container prior to use. 2,2,6,6Tetramethylpiperidine-1-oxyl (TEMPO) radical, sodium bromide (ACS grade), sodium hypochlorite (11-15% chlorine), and gold chloride (>64.4% Au) were purchased from Fisher. Silver nitrate solution (0.1 N) was purchased from SigmaAldrich.

Ag—Au—AgCl Nanohybrid Synthesis. LNCs (56.0 wt % cellulose and 27.2 wt % lignin) were prepared by chemical nanofibrillation of lignin-containing pulp. Ag—Au—AgCl nanohybrids were facilely synthesized by a simple mixing/staying method. A variety of lignin-containing nanocellulose prepared by different methods can also be used. 0.1 wt % was the only LNC concentration systematically tested in the experiments, but guidance can be provided on other LNC concentrations. If one assumes the relative amount of Ag and Au precursors and LNC follows the best results in the present experiments, then 0.1 wt % is the optimum concentration that could maintain good dispersibility after synthesis. Less than 0.1 wt % could even give better dispersibility, but the volume productivity—amount produced per unit volume—will be decreased. If good dispersibility is not desired, LNC concentration may go up to 0.2 wt %. If higher than 0.2 wt %, over growth of Ag—Au—AgCl nanohybrids may occur as more Ag and Au precursors are mixed together, which is not recommended as overgrowth will greatly compromise metallic nanoparticles' performances. In the experiments, 5 mM and 1 mM are the highest bounds of AgNO₃ and AuCl₃, respectively, to mix with 0.1 wt % LNC to obtain materials with good dispersibility and antibacterial activity. Lower concentrations can be used, and will simply result in lower volume productivity. The preferred optimum ranges of each reactant are 1˜5 mM of AgNO₃, 0.2˜1 mM AuCl₃, and 0.02˜0.1 wt % of LNC, respectively

Briefly, LNC suspension (0.1 wt % consistency) was mixed with an equal volume of AgNO₃ (5 mM), AuCl₃ (1-5 mM) in deionized water, or their mixtures in varied mixing ratios in deionized water, as summarized in the following table.

| | | | | | LNC/ | | | |
|---|---|---|---|---|---|---|---|---|
| | Initial | Initial | Initial | AgNO₃/ | (AgNO₃ + | Final | Final | |
| | LNC | [Ag⁺] | [Au³⁺] | AuCl₃ | AuCl₃) | [Ag⁺] | [Au³⁺] | [Au³⁺]/[Ag⁺] |
| Sample ^{a} | (wt %) ^{b} | (mM) ^{b} | (mM) ^{b} | (v/v) | (v/v) | (mM) | (mM) | molar ratio |
| T91-5 | 0.1 | 5 | 5 | 9:1 | 1:1 | 2.25 | 0.25 | 0.111:1 |
| T71-5 | 0.1 | 5 | 5 | 7:1 | 1:1 | 2.19 | 0.31 | 0.143:1 |
| T51-5 | 0.1 | 5 | 5 | 5:1 | 1:1 | 2.08 | 0.42 | 0.200:1 |
| T31-5 | 0.1 | 5 | 5 | 3:1 | 1.1 | 1.88 | 0.63 | 0.333:1 |
| T11-5 | 0.1 | 5 | 5 | 1:1 | 1:1 | 1.25 | 1.25 | 1.000:1 |
| T91-3 | 0.1 | 5 | 3 | 9:1 | 1:1 | 2.25 | 0.15 | 0.067:1 |
| T71-3 | 0.1 | 5 | 3 | 7:1 | 1:1 | 2.19 | 0.19 | 0.086:1 |
| T51-3 | 0.1 | 5 | 3 | 5:1 | 1:1 | 2.08 | 0.25 | 0.120:1 |
| T31-3 | 0.1 | 5 | 3 | 3:1 | 1:1 | 1.88 | 0.38 | 0.200:1 |
| T11-3 | 0.1 | 5 | 3 | 1:1 | 1:1 | 1.25 | 0.75 | 0.600:1 |
| T91-1 | 0.1 | 5 | 1 | 9:1 | 1:1 | 2.25 | 0.05 | 0.022:1 |
| T71-1 | 0.1 | 5 | 1 | 7:1 | 1:1 | 2.19 | 0.06 | 0.029:1 |
| T51-1 | 0.1 | 5 | 1 | 5:1 | 1:1 | 2.08 | 0.08 | 0.040:1 |
| T31-1 | 0.1 | 5 | 1 | 3:1 | 1:1 | 1.88 | 0.13 | 0.067:1 |
| T11-1 | 0.1 | 5 | 1 | 1:1 | 1:1 | 1.25 | 0.25 | 0.200:1 |
| T13-1 | 0.1 | 5 | 1 | 1:3 | 1:1 | 0.63 | 0.38 | 0.600:1 |
| T10 | 0.1 | 5 | — | 1:0 | 1:1 | 2.50 | 0 | 0 |
| T01-1 | 0.1 | — | 1 | 0:1 | 1:1 | 0 | 0.5 | — |

^{a} Labeling of samples is in the format of Tab-c, where T represents LNC, ab is volumetric ratio of AgNO₃/AuCl₃ solutions, and c is initial [Au³⁺] in mM.
^{b} Initial concentrations of LNC, Ag⁺ and Au³⁺ referred to the measures of the components in their individual suspension or solutions before mixing, and final concentrations referred to the measures of corresponding component after mixing.

The mixture was kept static at room temperature for 24 h. UV-vis data showed obvious formation occurred after 4 h, while the nanohybrids kept growing/forming till somewhere between 9 and 24 h. After 24 h the AgAu nanohybrids can remain stable for at least 6 weeks. Subsequently, the reaction mixtures were thoroughly washed by dialysis (12 000-14 000 Dalton) in deionized (DI) water for 30 min to remove unreacted ions. A LNC-free AgNP sample was synthesized by sodium borohydride and utilized as a positive control in the antibacterial assay. Briefly, 5 mL of 2.3 mM AgNO₃ solution was dropwise mixed with 30 mL of 10 mM NaBH₄ under vigorous stirring in an Erlenmeyer flask in an ice water bath. The synthesis was terminated by removing the flask from the ice water bath once the color of the solution became stable. Unless otherwise specified, freshly synthesized nanocomposite suspensions were characterized and evaluated for antibacterial activities.

Raising the temperature of the mixture reduces the time for synthesis. As an example, a boiling temperature (100° C.) completed the synthesis in 15 min. The nanohybrids' compositions were different from the room temperature sample, found on UV-vis spectra. The boiling-synthesized samples were less dispersible after synthesis and their antibacterial activities have not yet been tested. The change in dispersibility indicates that a very high temperature of boiling could affect the reaction mechanism and differ the composition/structure of AgAu nanohybrids. Temperatures less elevated from room temperature are expected to speed synthesis without altering the composition/structure of AgAu nanohybrids. Also, boiling at a time shorter than 15 minutes is expected to complete synthesis with less or no alteration of the composition/structure of AgAu nanohybrids.

Antibacterial Assay. Bacterial species of both Grampositive and Gram-negative, i.e., Staphylococcus aureus and Salmonella typhimurium, respectively, were used as the model strains to evaluate the antibacterial activities of monometallic AgNPs-, AuNPs-, and nanohybrids-LNC samples. First, the bacterial cells were inoculated from glycerol stock maintained at −20° C. into liquid Luria-Bertani (LB) media and incubated at 37° C. overnight. Thereafter, the cells were collected by 3000 g centrifugation for 5 min and resuspended in PBS buffer (pH7.4). Subsequently, the cell suspension was transferred to LB media (diluted 5-fold by water) to reach a final cell concentration of 10⁵-10⁶ CFU/mL. T10, T71-1, T11-1, T01-1, or pristine LNC was then mixed with the cell suspension at a final concentration of 2.5, or 10 μg/mL, with sterile DI water as a negative control. The cell cultures were incubated at 37° C. with 500 rpm for 18 h and then diluted by 10⁶-fold with PBS buffer and spread onto LB agar plates, followed by static cultivation at 37° C. for 24 h. Finally, the CFUs on the agar cultures were counted. The antibacterial efficacies were determined by the reduction of CFUs over the negative control using sterile DI water. The results were statistically analyzed using a one-factor analysis of variance (ANOVA), with at least four replicates for each antimicrobial assay.

Characterization. The compositions of LNC were determined following a two-stage acid hydrolysis. The (−potential of LNC was characterized by a Malvern Zetasizer (Malvern Instruments Ltd., GB). The LNC suspension was first diluted to a consistency of 0.02 wt % and then loaded in customized cells and scanned, setting water as the dispersant and the refractive index of LNC as 1.61. ⁵⁰UV-vis spectra of the metallic nanoparticles- and nanohybrids-LNC were obtained using a Cary 50 spectrophotometer (Varian, CA). The scanning was conducted from 200 to 800 nm at a middle speed with a background of pristine LNC suspension at a 0.05 wt % consistency. X-ray powder diffraction (XRD) was conducted with a Bruker SMART CCD system. Air-dried and pulverized samples were scanned at 0.020 step from 20 to 70°. High resolution transmission electron microscopy (HR-TEM) imaging was performed using both a JEOL JEM-1400 TEM and an FEI Tecnai F30 TEM equipped with an Oxford ultrathin window energy-dispersive X-ray (EDX) spectroscopy detector, running at 200 kV. Cell morphology was imaged with a JEOL JEM-1400 TEM. Bacterial cells of 10⁶-10⁷ CFU/mL were treated with 10 μg/mL nanohybrids-LNC sample (T711) in PBS buffer (pH7.4) with an agitation rate of 500 rpm at 37° C. for 30 min. The cells were then collected via centrifugation at 14000 rpm for 30 s and resuspended in 2% glutaraldehyde fixative for at least 30 min at room temperature for cell fixation. Silver ion release was analyzed by a Thermo Scientific iCAP 7000 Plus Series inductively coupled plasmaoptical emission spectrometry (ICP-OES). Silver was detected at 243.78 nm with a linear calibration range from 0.1 to 100 μg/mL. In the release test, AgNPs- or nanohybrids-LNC samples were added to 10 μg/mL in 12 mL of diluted LB media and agitated at 500 rpm. Samples were collected at 0, 1, 2.6, and 12 h, and then centrifuged at 12000 g for 10 min to remove silver particles while retaining Ag⁺ ions. X-ray photoelectron spectroscopy (XPS) was conducted with a Thermo Scientific Nexsa PS system using a true monochromatic AlKα X-ray source (72 W, 400 μm slot). Whole spectrum survey (0.50 eV/step, dwell time 50 ms, pass energy 200 eV) and high-resolution scans (0.10 eV/step, dwell time 50 ms, pass energy 50 eV) of specific elements (C, 0, C1, Ag, Au) were both acquired. XPS spectra were analyzed with CasaXPS software and peak fitting was based on the Gaussian-Lorentzian line shape and Shirley background. Fourier transform infrared spectroscopy (FTIR) was conducted using a Nicolet 4700 FTIR spectrometer (Thermo Electron Corp., Waltham, MA) in attenuated total reflectance (ATR) mode equipped with a germanium crystal surface. All samples were scanned at 4 cm⁻¹ per step through 400 to 4000 cm⁻¹ wavenumbers.

Simulation of water treatment was conducted in two stages, water disinfection and Ag⁺ ion absorption. In water disinfection test, bacteria contaminated water samples were prepared by inoculating S. aureus and E. coli strains into sterile deionized water, each strain to 105 CFU/mL. Next, T71-1 sample was added to the water samples to a final concentration of 5 or 10 μg/mL, while sterile DI water was used as blank control. All water samples were kept under room temperature with moderate shaking for 30 min, and then picked for plate spreading for CFU counting. Killing ratio equals to the CFU decreased compared with blank control. In the second stage, Ag⁺ ion absorption, AuNPs-LNC was utilized as the absorbent, of which the synthesis reaction remained the same while the amount of AuCl₃ (1 mM) was just 2.5 mL/20 mL LNC (0.1 wt %), and 17.5 mL DI water was also mixed with AuCl³ and LNC to synthesize AuNPs-LNC. To test the absorption effectiveness, disinfected water samples from the first stage were first centrifugated at 12000×g for 10 min to remove T71-1 nanoparticles and the supernatants were utilized as the water specimen to add AuNPs-LNC to a final concentration of 10 μg/mL. After 24 h mixing under room temperature and moderate shaking, the samples were centrifugated again at 12000×g for 10 min to remove AuNPs-LNC nanoparticles, and the supernatants were collected to be analyzed by ICP-OES together with the supernatants before absorption. This demonstrates that the present nanohybrids can be used for water treatment in view of the Ag⁺ ion absorption. The nanohybrid is capable of absorbing Ag⁺ ions, or even to in situ synthesize AgAu nanohybrids-LNC to avoid Ag⁺ release to environment and to provide recycling and reuse of silver.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for green Ag—Au—AgCl lignin-containing nanocellulose (LNC) nanohybrid formation, the method comprising:
mixing gold and silver metallic precursors in solution with lignin-containing nanocellulose (LNC);
maintaining the solution for a predetermined time period to permit Ag—Au—AgCl nanohybrid formation via reduction of the metallic precursors by the LNC.

2. The method of claim 1, wherein the maintaining is conducted at room temperature.

3. The method of claim 2, wherein the predetermined time period is at least 4 hours.

4. The method of claim 3, wherein the predetermined time period is at least 9 hours.

5. The method of claim 3, wherein the predetermined time period is between 4 hours and 24 hours.

6. The method of claim 1, wherein the maintaining is conducted a temperature ranging from room temperature to boiling (100° C.).

7. The method of claim 6, wherein the predetermined time period is at least a few minutes.

8. The method of claim 7, wherein the predetermined time period is up to 15 minutes.

9. The method of claim 1, wherein the gold and silver metallic precursors are mixed in a molar ratio of 0.020-0.040:1 in gold precursor/silver precursor.

10. The method of claim 4, wherein the gold and silver precursors comprise AuCl₃ and AgNO₃.

11. The method of claim 10, wherein ratios in the mixing comprise 1˜5 mM of AgNO₃, 0.2˜1 mM AuCl₃, and 0.02˜0.1 wt % of LNC.

12. A nanohybrid comprising or consisting of Ag—Au—AgCl nanoparticles embedded in LNC.

13. A method of treating water, comprising dispersing a nanohybrid according to claim 12 in water to be treated.

14. A method of Ag⁺ ion absorption, comprising dispersing an Au—AgCl lignin-containing lanocellulose (LNC) nanohybrid in a solution and permitting Ag—Au—AgCl nanohybrid formation.
